(19) United States
(12) Patent Application Publication
(10) Pub. No.: US 2026/0279401 A1
(43) Pub. Date: Sep. 17, 2026

(54) IMAGING APPARATUS AND AUDIO PROCESSING DEVICE

(71) Applicant: Panasonic Intellectual Property Management Co., Ltd., Osaka (JP)

(72) Inventor: Hiroki KASUGAI, Osaka (JP)

(73) Assignee: Panasonic Intellectual Property Management Co., Ltd., Osaka (JP)

(21) Appl. No.: 19/559,966

(22) Filed: Mar. 7, 2026

(30) Foreign Application Priority Data
Mar. 11, 2025 (JP) 2025-037992

(51) Int. Cl. G11B 27/031

(52) U.S. Cl. CPC G11B 27/031

(57) ABSTRACT

An imaging apparatus incudes: an image sensor configured to capture a subject image to generate image data; an audio processor configured to collect an input sound in imaging by the image sensor, to generate first audio data indicating the input sound in a first dynamic range; and a controller configured to edit the first audio data generated by the audio processor to output second audio data indicating output sound corresponding to the input sound in a second dynamic range smaller than the first dynamic range.

### TECHNICAL FIELD

The present disclosure relates to an imaging apparatus and an audio processing device that perform a recording operation such as float recording.

### BACKGROUND ART

JP 2015-185904 A discloses an imaging apparatus that aims to allow a user to arbitrarily set a parameter of audio signal processing performed on an audio signal to be recorded with an easy operation. The imaging apparatus sets the sound processing parameter according to a user operation in a pattern having a shape identical or similar to that of an image setting means for setting the image processing parameter. JP 2015-185904 A discloses, as the sound processing parameters set in this manner, a parameter for signal processing for cutting noise included in the audio signal, a parameter for signal processing for emphasizing a stereo feeling of the audio signal, and a parameter for signal processing for cutting wind noise of the audio signal.

### SUMMARY

The present disclosure provides an imaging apparatus and an audio processing device capable of facilitating a user to obtain an editing result of audio data.

In the present disclosure, an imaging apparatus incudes: an image sensor configured to capture a subject image to generate image data; an audio processor configured to collect an input sound in imaging by the image sensor, to generate first audio data indicating the input sound in a first dynamic range; and a controller configured to edit the first audio data generated by the audio processor to output second audio data indicating output sound corresponding to the input sound in a second dynamic range smaller than the first dynamic range.

In the present disclosure, an audio processing device audio processing device includes: an audio processor configured to collect an input sound to generate first audio data indicating the input sound in a first dynamic range; and a controller configured to edit the first audio data generated by the audio processor to output second audio data indicating output sound corresponding to the input sound in a second dynamic range smaller than the first dynamic range.

According to the imaging apparatus and the audio processing device of the present disclosure, it is possible to facilitate the user to obtain the editing result of the audio data.

### BRIEF DESCRIPTION OF THE DRAWINGS

FIG. 1 is a diagram illustrating a configuration of a digital camera according to a first embodiment of the present disclosure;

FIG. 2 is a diagram illustrating a circuit configuration for float recording in the digital camera;

FIG. 3 is a flowchart illustrating an operation of the digital camera according to the first embodiment;

FIG. 4 is a diagram for explaining dynamics control in the digital camera;

FIG. 5 is a diagram illustrating dynamics control data of compressor processing in the digital camera;

FIGS. 6A to 6F are waveform diagrams for explaining a float recording operation in the digital camera;

FIG. 7 is a diagram for explaining a data Structure in a float format;

FIG. 8 is a flowchart illustrating an example of automatic analysis process in the digital camera;

FIGS. 9A to 9C are diagrams for explaining an operation example of proposing compressor processing in the digital camera;

FIGS. 10A to 10C are diagrams for explaining an operation example of proposing normalization processing in the digital camera;

FIG. 11 is a flowchart illustrating float audio editing process in the digital camera;

FIGS. 12A and 12B are diagrams showing a display example of float audio editing process in the digital camera;

FIG. 13 is a diagram illustrating dynamics control data of expander processing in the digital camera;

FIG. 14 is a diagram illustrating dynamics control data of averaging processing in the digital camera; and

FIG. 15 is a flowchart illustrating an operation of the digital camera of a modification example.

### DETAILED DESCRIPTION

Hereinafter, embodiments will be described in detail with reference to the drawings as appropriate. However, detailed description of well-known matters and redundant description of substantially the same configuration may be omitted. The accompanying drawings and the following description are provided for those skilled in the art to fully understand the present disclosure, and are not intended to limit the subject matter described in the claims.

### First Embodiment

In a first embodiment, a digital camera that performs float recording will be described as an example of an imaging apparatus (and an audio processing device) according to the present disclosure. The float recording is a recording function having a wide dynamic range by a predetermined data format such as a float format.

### 1. Configuration

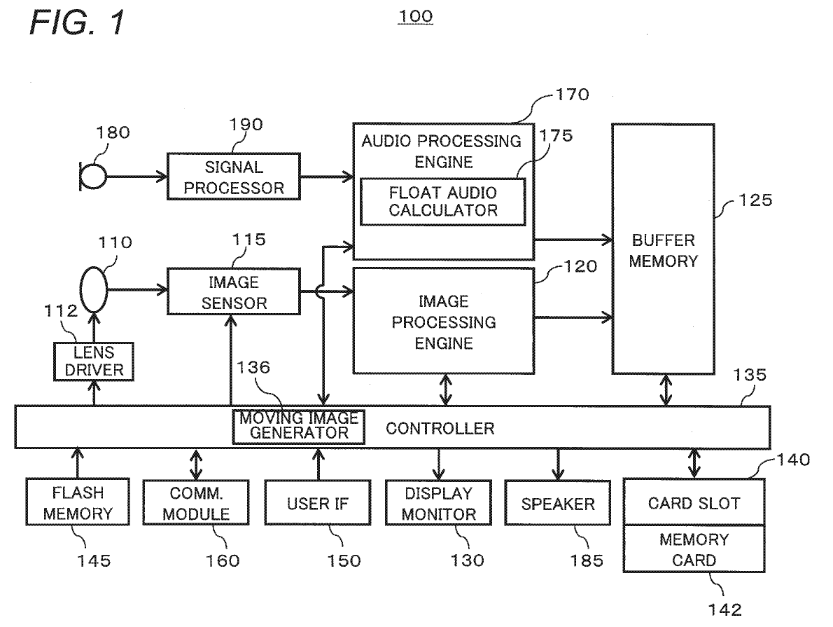

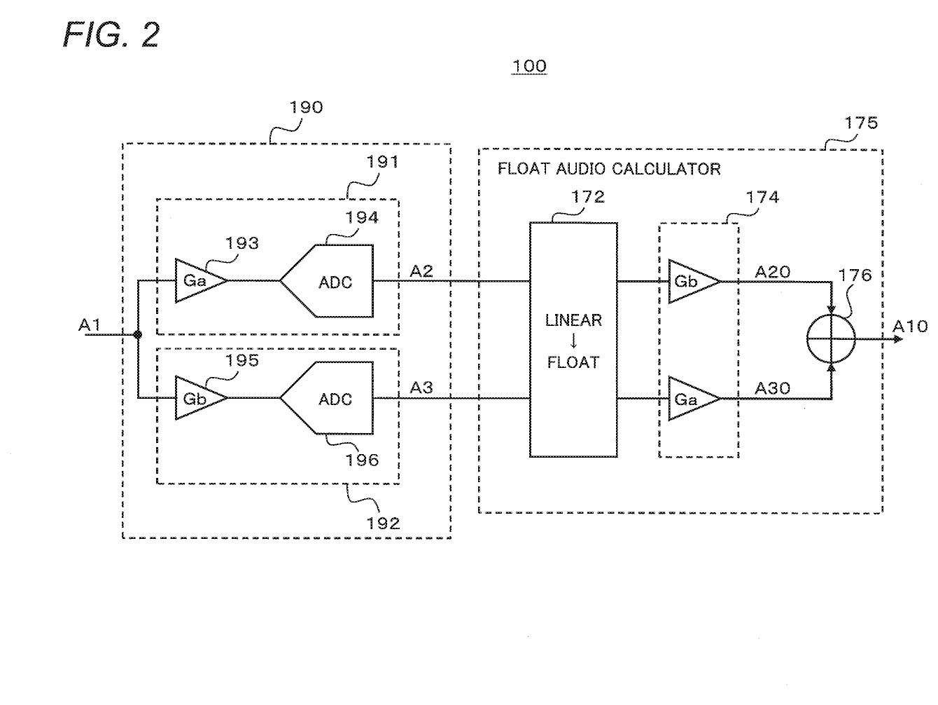

A configuration of a digital camera 100 according to the present embodiment will be described with reference to FIGS. 1 and 2.

FIG. 1 is a diagram illustrating a configuration of a digital camera 100 according to the present embodiment. The digital camera 100 of the present embodiment includes an image sensor 115, an image processing engine 120, a display monitor 130, and a controller 135. The digital camera 100 further includes a buffer memory 125, a card slot 140, a flash memory 145, a user interface 150, a communication module 160, an audio processing engine 170, a microphone 180, a speaker 185, and a signal processor 190. The digital camera 100 includes, for example, an optical system 110 and a lens driver 112.

The optical system 110 includes a focus lens, a zoom lens, an optical image stabilizer (OIS), a diaphragm, a shutter, and the like. The focus lens is a lens for changing a focus state of a subject image formed on the image sensor 115. The zoom lens is a lens for changing the magnification of a subject image formed by the optical system. The focus lens and the like are each constituted by one or more lenses.

The lens driver 112 drives a focus lens and the like in the optical system 110. The lens driver 112 includes a motor, and moves the focus lens along the optical axis of the optical system 110 based on the control of the controller 135. The configuration of driving the focus lens in the lens driver 112 can be realized by a DC motor, a stepping motor, a servo motor, an ultrasonic motor, or the like.

The image sensor 115 captures a subject image formed via the optical system 110 and generates imaging data. The imaging data constitutes image data indicating an image captured by the image sensor 115. The image sensor 115 generates image data of a new frame at a predetermined frame rate (e.g., 30 frames / second). The generation timing of the imaging data and the electronic shutter operation in the image sensor 115 are controlled by the controller 135. As the image sensor 115, various image sensors such as a CMOS image sensor, a CCD image sensor, or an NMOS image sensor can be used.

The image sensor 115 executes an imaging operation of a moving image and a still image, an imaging operation of a through image, and the like. The through image is mainly a moving image, and is displayed on the display monitor 130 for the user to determine a composition for capturing a still image, for example. The through image, the moving image, and the still image are examples of a captured image in the present embodiment. The image sensor 115 is an example of an image sensor in the present embodiment.

The image processing engine 120 performs various processing on the imaging data output from the image sensor 115 to generate image data, or performs various processing on the image data to generate an image to be displayed on the display monitor 130. Examples of the various processing include white balance correction, gamma correction, YC conversion processing, electronic zoom processing, compression processing, and decompression processing, but the various processing are not limited thereto. The image processing engine 120 may be configured by a hard-wired electronic circuit, or may be configured by a microcomputer, a processor, or the like using a program.

The display monitor 130 is an example of a display that displays various types of information. For example, the display monitor 130 displays an image (through image) represented by image data that is captured by the image sensor 115 and is subjected to image processing by the image processing engine 120. The display monitor 130 displays a menu screen or the like for the user to perform various settings on the digital camera 100. The display monitor 130 can be configured by, for example, a liquid crystal display device or an organic EL device.

The user interface 150 is a general term for hard keys such as operation buttons and operation levers provided on the exterior of the digital camera 100, and receives operations by the user. For example, the user interface 150 includes, a release button, a mode dial, a touch panel, a cursor button, and a joystick. When the user interface 150 receives an operation by the user, the user interface 150 transmits an operation signal corresponding to the user operation to the controller 135.

The controller 135 performs overall control of the whole operation of the digital camera 100. The controller 135 includes a CPU and the like, to realize a predetermined function by the CPU executing a program (software). For example, the controller 135 functions as a moving image generator 136 that controls a decoder that decodes a signal received from the communication module 160 or an encoder of video and audio to generate a moving image file.

The decoder may not be implemented by the function of the controller 135, and may be incorporated in the communication module 160, for example. The moving image generator 136 is not limited to the function of the controller 135, and may be realized in cooperation with the various engines 120,170 or may be implemented in a circuit manner. The controller 135 may include a processor configured by a dedicated electronic circuit designed to realize a predetermined function, instead of the CPU. That is, the controller 135 can be realized by various processors such as a CPU, an MPU, a GPU, an NPU, a DSP, an FPGA, and an ASIC. The controller 135 may be configured by one or more processors or circuitry. The controller 135 may be configured by one semiconductor chip together with the image processing engine 120 and the like.

The buffer memory 125 is a recording medium that functions as a work memory of the image processing engine 120 and the controller 135. The buffer memory 125 is implemented by a dynamic random access memory (DRAM) or the like. The flash memory 145 is a nonvolatile recording medium. Although not illustrated, the controller 135 may include various internal memories, and may include a ROM, for example. The ROM stores various programs to be executed by the controller 135. The controller 135 may include a RAM that functions as a work area of the CPU.

The card slot 140 is a means into which a detachable memory card 142 is inserted. The card slot 140 can electrically and mechanically connect the memory card 142. The memory card 142 is an external memory including a recording element such as a flash memory. The memory card 142 can store data such as image data generated by the image processing engine 120.

The communication module 160 is a module (circuit) that connects to an external device in accordance with a predetermined communication standard in wired or wireless communication. For example, the predetermined communication standard includes WiFi, USB, HDMI, IEEE 802.11, and the like. The digital camera 100 can communicate with a communication network such as the Internet or other devices via the communication module 160. The communication module 160 is an example of a communication interface in the present embodiment.

The audio processing engine 170 performs various audio processing on an audio signal acquired from the outside or the inside of the digital camera 100, to generates audio data as a processing result, for example. The audio processing engine 170 is an example of an audio processor in the present embodiment. The audio processing engine 170 may be integrally configured with one or both of the image processing engine 120 and the controller 135.

The microphone 180 is an example of an audio input interface including one or more microphone elements built in the digital camera 100, for example. The microphone 180 inputs single channel or multiple channels of input sound to the digital camera 100. For example, the microphone 180 outputs an analog signal (which is an electric signal) indicating the collected sound to the signal processor 190. In the digital camera 100, an external microphone 180 may be used.

The digital camera 100 may include a connector such as a terminal connected to an external microphone as an audio input interface alternatively or additionally to the built-in microphone 180. The digital camera 100 may include an accessory shoe such as a hot shoe or a cold shoe, a connection plug, or the like as such a connector.

The signal processor 190 is a signal processing circuit that performs signal processing such as analog/digital (A/D) conversion on an analog signal from the microphone 180, for example. The signal processor 190 outputs the audio signal of the signal processing result to the audio processing engine 170. The signal processor 190 includes a circuit configuration for float recording in the digital camera 100.

The speaker 185 includes, for example, one or more speaker elements built in the digital camera 100 and a digital/analog (D/A) converter, and outputs audio to the outside of the digital camera 100 under the control of the controller 135. The D/A converter for audio output includes, for example, switches and voltage dividing circuits corresponding to the number of bits of audio data, to convert audio data in a digital format such as a linear format into an audio signal in an analog format, and output the audio signal to a speaker element.

The speaker 185 is an example of an audio output interface in the present embodiment. In the digital camera 100, an external speaker, an earphone, or the like may be used. The digital camera 100 may include a connector connected to an external speaker or the like and a D/A converter for audio output as an example of the audio output interface, alternatively or additionally to the built-in speaker 185.

### 1-1. Circuit Configuration of Float Recording

The configuration of the signal processor 190 and the like for float recording in the digital camera 100 of the present embodiment will be described with reference to FIG. 2.

For example, the signal processor 190 of the digital camera 100 includes, as a circuit configuration for float recording, a high (H) level signal processor 191 and a low (L) level signal processor 192 for each input sound of one channel, as illustrated in FIG. 2.

Each signal processor 191, 192 is configured by a signal processing circuit including an amplifier 193, 195 and an A/D converter 194,196, as illustrated in FIG. 2, for example. Different gains Ga and Gb are set in the signal processors 191, 192 and so as to share the entire dynamic range of the digital camera 100.

In the amplifier 193 of the H level signal processor 191, a gain Ga is set so as to reduce the influence of circuit noise from the viewpoint of accurately collecting an input sound having a relatively small volume, for example. For example, the gain Ga is larger than the gain Gb of the L level signal processor 192. Thus, the H level signal processor 191 has a dynamic range on the low volume side.

In the amplifier 195 of the L level signal processor 192, a gain Gb is set so as to suppress saturation distortion of a signal waveform from the viewpoint of accurately collecting an input sound having a relatively large volume, for example. In this way, the L level signal processor 192 has a dynamic range on the large volume side.

The dynamic range of the H-level signal processor 191 and the dynamic range of the L-level signal processor 192 are, for example, continuous, and may partially overlap each other. The A/D converters of the signal processors 191, 192 have circuit characteristics common to each other, such as resolution. One or more signal processors 191, 192 may be integrated on an IC chip.

As illustrated in FIG. 2, the audio processing engine 170 of the present embodiment includes, as the float audio calculator 175, a data conversion unit 172, an amplification unit 174 and a combining unit 176, for example. The float audio calculator 175 is a functional configuration that performs calculation processing for realizing float recording (details will be described later).

The digital camera 100 according to the present embodiment may further include a multiplexer between the signal processor 190 and the data conversion unit 172, for example. The multiplexer may selectively switch between input of the audio signals A2 and A3 from the signal processors 191, 192 and of the digital camera 100 and input of the audio signal of the H/L level from the external sound pickup device. In addition, not only the audio signal A1 input from the microphone 180 inside the digital camera 100 but also the audio signal A1 from an external microphone may be input to each signal processor 191, 192.

### 2. Operation

The operation of the digital camera 100 configured as described above will be described.

In the present embodiment, the digital camera 100 executes float recording during shooting of a moving image, for example. According to the float recording operation of the digital camera 100, it is possible to ensure the resolution of each sound from a relatively larger volume sound to a smaller volume sound by a wide dynamic range of a float type, for example.

This can facilitate the user of the digital camera 100 to avoid a failure in moving image shooting, such as a sound break in which the recorded sound is too loud or a sound that is too small, by using the float recording operation during moving image shooting, for example. For example, an advanced user capable of handling audio editing software can accurately perform desired post-editing, and thus can realize the advantage of the float recording that high-quality audio can be obtained.

On the other hand, as it is conventionally assumed that the audio data of the float recording is edited after the recording, the post-editing using the audio editing software might be a burden for a beginner user or the like, for example. As in a typical digital camera or the like, the audio data of the float recording cannot be reproduced due to the performance of a D/A converter or the like mounted thereon and it is difficult to reproduce or play high-quality sound without editing, there would be difficulty for the user to feel the advantage of the float recording immediately after the image shooting. For this reason, the conventional technology has a problem in terms of ease of use of the float recording in a digital camera or the like.

Therefore, the digital camera 100 of the present embodiment performs audio processing in which audio is edited with high quality by an operation simple for the user according to audio data generated by the float recording operation (hereinafter also referred to as "float audio data"), and outputs the audio data of the editing result in a reproducible manner. Hereinafter, the operation of the digital camera 100 according to the present embodiment will be described in detail.

### 2-1. Overall Operation

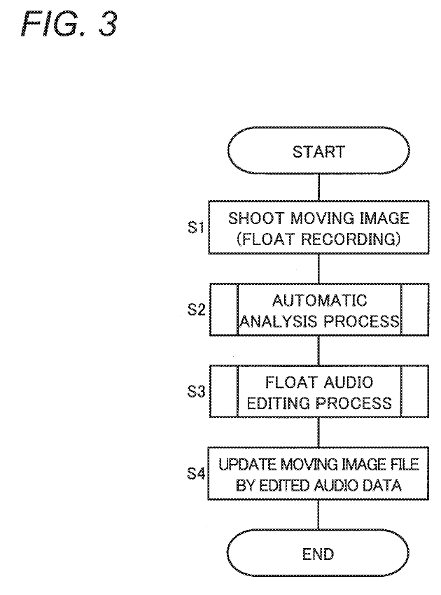

The overall operation from float recording to audio editing in the digital camera 100 according to the present embodiment will be described with reference to FIGS. 3 to 5.

FIG. 3 is a flowchart illustrating an operation of the digital camera 1 according to the present embodiment. Each process illustrated in the flowchart of FIG. 3 is executed by the controller 135 of the digital camera 100.

First, the controller 135 executes shooting and recording of a moving image using float recording in accordance with a user operation on the user interface 150 of the digital camera 100, for example (S1). In step S1, various operations for shooting and recording a moving image including a float recording operation are performed in the digital camera 100. Whether or not to perform the float recording in the moving image shooting can be set by a user operation on a setting menu of the digital camera 100, for example. The details of the float recording operation in the step S1 will be described later.

Next, the controller 135 executes automatic audio analysis on audio data in a float format (hereinafter also referred to as "float audio data") in the shot moving image file, for example (S2). In the present embodiment, the automatic analysis process (S2) automatically determines an editing method suitable for the float audio file to be edited in the digital camera 100, for example. The details of the process of step S2 will be described later.

Next, based on the result of the automatic analysis process (S2), the controller 135 performs processing for editing the float audio data in accordance with the intention of the user, for example (S3). The float audio editing process (S3) in the digital camera 100 of the present embodiment proposes an editing method for controlling how strong/weak the sound in data, i.e. dynamics, to the user in accordance with the characteristics of the float audio data analyzed in the automatic analysis process (S2).

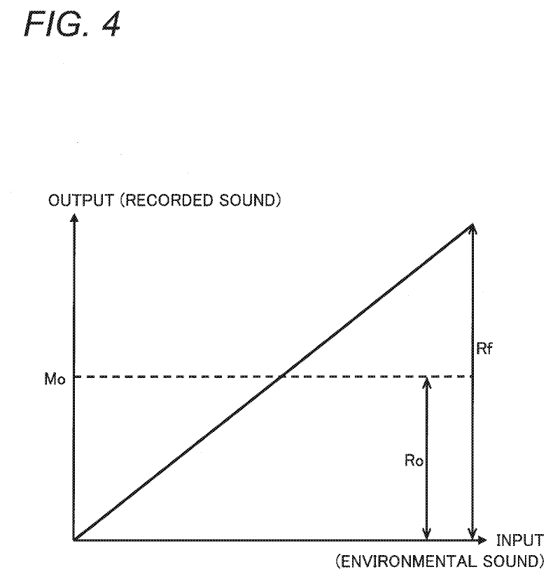

FIG. 4 is a diagram for explaining dynamics control in the digital camera 100 according to the present embodiment. In the graph of FIG. 4, the horizontal axis represents the magnitude of input sound such as environmental sound, and the vertical axis represents the magnitude of sound recorded in a float format or a linear format.

In the following, an example in which the output of the editing result in the digital camera 100 is audio data in a linear format (also referred to as "linear audio data") will be described. The linear format is a data format for recording linear PCM (pulse code modulation) in 24 bits or the like with the float format being 32 bits, for example. The linear audio data can be reproduced by the speaker 185 of the digital camera 100. The number of bits of each format is not particularly limited to the above example, and the linear format may be 16 bits, for example.

FIG. 4 illustrates a range Rf in which audio data can be recorded in the float format and a range Ro in which audio data can be recorded in the linear format. The recording ranges Rf and Ro of the respective formats are examples of the first and second dynamic ranges in the present embodiment, respectively.

As illustrated in FIG. 4, the recording range Rf of the float type is wider than the recording range Ro of the linear format. Therefore, when the float recording operation of the step S1 records various input sounds widely in the recording range Rf of the float forma, the recording result exceeds the maximum value Mo of the recording range Ro of the linear format to be output.

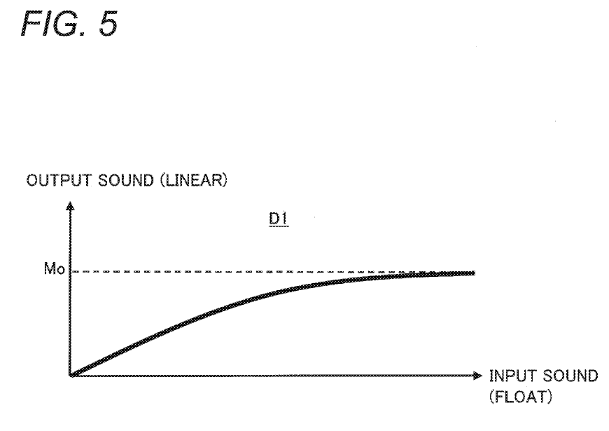

Therefore, the digital camera 100 of the present embodiment performs audio editing processing of dynamics control such that the dynamics of the recorded audio falls within the recording range Ro of the linear format from the recording range Rf of the float format (S3). An example of such processing will be described with reference to FIG. 5.

FIG. 5 illustrates dynamics control data D1 of compressor processing in the digital camera 100 of the present embodiment. In the graph of FIG. 5, the horizontal axis represents the volume of the input sound indicated by the float audio data, for example. The vertical axis represents the volume of the output sound indicated by the linear audio data, for example.

The dynamics control data D1 defines a correspondence between a change in the volume of the input sound and a change in the volume of the output sound, as shown in FIG. 5, for example. For example, the dynamics control data D1 of the compressor processing illustrated in FIG. 5 suppresses the degree of increase in the volume of the output sound as the volume of the input sound increases, to keep the volume of the output sound within a range not exceeding the maximum value Mo of the recording range Ro of the linear format. According to such compressor processing, within the recording range Ro of the linear format, audio editing can be performed such that a large volume portion or the like in the recorded output sound is given a sense of unity, for example.

In the digital camera 100 of the present embodiment, for example, the controller 135 performs the dynamics control editing process on the float audio data with reference to the dynamics control signal D1, to generate a linear audio data as an editing result (S3). The details of the process of step S3 will be described later.

Next, the controller 135 stores the editing result of the float audio data as described above in the memory card 142 via the card slot 140, for example (S4).

For example, the controller 135 updates the moving image file such that the moving image file of the shooting result of the step S1 includes the linear audio data of the editing result of the step S3 instead of the float audio data (S4). At this time, the float audio data of the editing source may be separately recorded in the memory card 142, or may be appropriately associated with the moving image file of the editing destination. Alternatively, the linear audio data of the editing result may be recorded separately from the moving image file.

The controller 135 ends the processing illustrated in FIG. 3 by saving (S4) the editing result for the float audio data.

According to the above processing, the digital camera 100 of the present embodiment performs editing processing (S3) in accordance with a user operation after automatic audio analysis (S2) on float audio data obtained by moving image shooting, for example (S1). The digital camera 100 according to the present embodiment can output linear audio data that can be reproduced with high quality (S4) as a result of the editing, and can allow the user to easily experience the advantage of the float recording.

For example, a user who has performed moving image shooting (S1) by float recording in the digital camera 100 can obtain a moving image file (S4) in which float audio data has been edited on the spot, and can aurally experience high-quality audio of the editing result by reproduction in the speaker 185 or the like. The user can upload a moving image file shot with float recording from the communication module 160 of the digital camera 100 to the Internet or the like in a state where the float audio data has been edited, and can easily use the digital camera 100.

In the above description, an example in which the processing for audio editing (S1 to S4) is performed on the shooting result after the moving image shooting of step S2 has been described. The digital camera 100 according to the present embodiment may allow the user to select such a moving image file to be edited. For example, the controller 135 lists moving image files including audio data in the float format as options on the display monitor 130 among the moving image files stored in the memory card 142, to receive a user operation of selecting any one of the moving image files on the user interface 150. The controller 135 may perform the processing of step S2 and subsequent steps on the selected moving image file.

In the above description, an example in which the controller 135 of the digital camera 100 executes the processing of steps S1 to S4 has been described. For example, a part or the whole of the automatic analysis process (S2) may be performed by a server or the like that can communicate with the digital camera 100. For example, the controller 135 may transmit the float audio data to an external server via the communication module 160 and receive the analysis result of the float audio data from the external server.

In the digital camera 100 according to the present embodiment, the automatic analysis process (S2) may be executed in response to a user operation for instructing execution of analysis on the user interface 150. For example, when no such instruction, the automatic analysis process (S2) may be omitted.

### 2-2. Float Recording Operation

The float recording operation in the step S1 in FIG. 3 in the digital camera 100 of the present embodiment will be described in detail with reference to FIGS. 2 to 7.

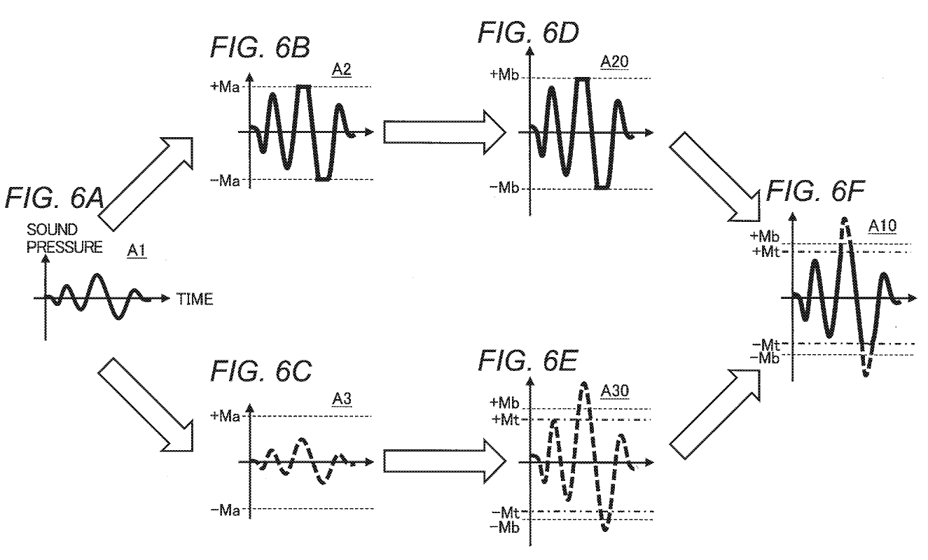

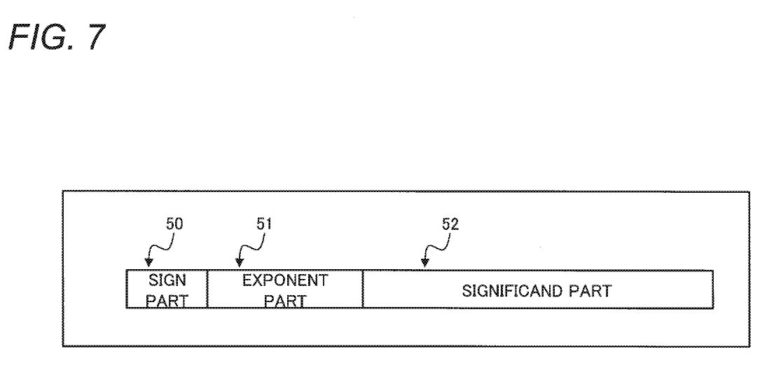

FIGS. 6A to 6F are waveform diagrams for explaining the float recording operation in the present system 10. FIG. 7 is a diagram for explaining a data structure in the float format.

For example, in the digital camera 100, an input audio signal A1 indicating input sound acquired by the microphone 180 is input to the H level signal processor 191 and the L level signal processor 192, as shown in FIG. 2. An example of the input audio signal A1 is illustrated in FIG. 6A. In the waveform diagram of FIG. 6A, the horizontal axis represents time, and the vertical axis represents sound pressure (the same applies hereinafter). The input audio signal A1 may be input from a microphone outside the digital camera 100.

In the H level signal processor 191, the amplifier 193 amplifies the input audio signal A1 with a gain Ga set to a relatively large value. The A/D converter 194 performs A/D conversion to convert the amplification result of the input audio signal A1 in the amplifier 193 from analog signals to digital signals, to generate an H-level audio signal A2. The processing of the input audio signal A1 in the H level signal processor 191 is an example of the first amplification conversion in the present embodiment.

FIG. 6B illustrates an audio signal A1 of the H level obtained from the input audio signal A2 of the example of FIG. 6A. In the example of FIG. 6B, waveform distortion occurs in the H-level audio signal A2 near the maximum value Ma that can be output by each signal processor 191, 192. On the other hand, according to the audio signal A2 of the H level, the signal to noise ratio is high as the gain Ga is large.

In the L level signal processor 192, the amplifier 195 amplifies the input audio signal A1 with a gain Gb set to a relatively small value. The A/D converter 196 A/D-converts the amplification result of the input audio signal A1 in the amplifier 195 from analog signals to digital signals, to generate an L-level audio signal A3. The processing of the input audio signal A1 in the L level signal processor 192 is an example of the second amplification conversion in the present embodiment.

FIG. 6C illustrates an L-level audio signal A3 obtained from the input audio signal A1 in the example of FIG. 6A. The audio signal A3 of the L level is less likely to cause distortion of the signal waveform than the audio signal A2 of the H level. On the other hand, the signal-to-noise ratio is low since the gain Gb is small.

The audio signals A2, A3 generated by the signal processors 191, 192 are linear digital signals representing sound as digital values in a predetermined dynamic range (± Ma) and resolution. The digital camera 100 may receive the two audio signals A2 and A3 generated in an external sound pickup device in the same manner as described above, and perform the remaining arithmetic processing for float recording.

In the digital camera 100 of the present embodiment, the float audio calculator 175 of the sound processing engine 170 executes the float calculation processing by performing calculations corresponding to a data conversion unit 172, an amplification unit 174, and a combining unit 176, as illustrated in FIG. 2, for example.

In the audio processing engine 170 of the digital camera 100, the data conversion unit 172 converts the audio signals A2 and A3, obtained from the sound pickup device 200, from the linear format to the float format. The data structure of the float format will be described with reference to FIG. 7.

The float format is a data format in which a data value is represented by a floating-point type. For example, the data structure in the float format includes a sign part 50, an exponent part 51, and a significand part 52 as illustrated in FIG. 7.

The sign part 50 is a part indicating a positive or negative sign in a bit string indicating a data structure of a float format, for example. The sign portion 50 may be omitted from the data structure in the float format as appropriate.

The exponent part 51 is a part indicating a power exponent in an exponent notation of the data value in the bit string in the float format. For example, the exponential notation has a base 2 in binary. The exponent part 51 manages the level of the volume corresponding to the position of the decimal point in such notation.

The significand part 52 is a part indicating significant figures of the data value in the bit string of the float format. For example, the resolution of the audio data is increased as the number of bits allocated to the significand part 52 increases.

In the float format, a predetermined amount of bits defining the bit string is set by being distributed in advance among the sign part 50, the significand part 52, and the exponent part 51. For example, in a 32-bit float recording, the sign portion 50 has one bit, the exponent portion 51 has eight bits, and the significand portion 52 has 23 bits. According to the audio data in the float format, the resolution corresponding to the number of bits of the significand part 52 can be ensured in the recording range Rf (FIG. 4) of the wide dynamic range over the sound volume level corresponding to the number of bits of the exponent part 51.

The audio processing engine 170 as the data conversion unit 172 sequentially calculates the values of the exponential part 51 and the values of the significand part 52 so as to normalize, in a floating-point type, the values indicated by the audio signal A2 at the H level at each time, to generate audio data in a float format, for example. Similarly, the audio processing engine 170 performs a floating-point normalizing operation on the L-level audio signal A3 to generate audio data in the float format. The audio data generated in this manner indicates a higher volume as the value of the exponent part 51 is larger. The normalization is performed by sequentially increasing the value of the exponent part 51 until the most significant digit of the significand part 52 is not zero, for example.

Returning to FIG. 2, in the audio processing engine 170, the amplification unit 174 performs an amplification operation for canceling out a difference between the gains Ga and Gb based on gain information indicating the gains Ga and Gb of the amplifiers 193 and 195, for example.

For example, in the audio processing engine 170, the amplification unit 174 calculates the H-level audio signal A2 so as to amplify the conversion result of the H-level audio data A20 in the float format by the lower gain Gb, in the floating-point arithmetic. Similarly, the amplification unit 174 calculates the L-level audio signal A3 so as to amplify the conversion result of the L-level audio data A30 by the amount of the higher gain Ga.

FIG. 6D illustrates the H-level audio data A20 calculated from the H-level audio signal A2 of FIG. 6B. FIG. 6E illustrates the L-level audio data A30 calculated from the L-level audio signal A3 of FIG. 6C. According to the calculation of the amplification unit 174, as illustrated in FIGS. 6D and 6E, the volume of the H-level audio data A20 and the volume of the L-level audio data A30 can be made equal to each other, for example.

Next, the combining unit 176 in the audio processing engine 170 generates the float audio data A10 by performing arithmetic processing of combining the H-level audio data A20 and the L-level audio A30 with switching therebetween, for example. FIG. 6F illustrates the float audio data A10 generated from the audio data A20 and A30 of FIGS. 6D and 6E.

For example, the combining unit 176 compares the magnitude (absolute values) of the L-level audio A30 with a predetermined threshold Mt. When the L-level audio A30 is equal to or greater than the threshold Mt, the combining unit 176 adopts the L-level audio A30 as the float audio data A10. On the other hand, when the L-level audio data A30 is less than the threshold Mt, the combining unit 176 adopts the H-level audio data A20 as the float audio data A10. The threshold Mt is set to a value equal to or less than the maximum value Mb of the output of each signal processor 191, 192 in each of the audio data A20 and A30.

During the step S1 (FIG. 3) in which the float recording operation is performed as described above, in the digital camera 100, the image sensor 115 performs imaging for each frame of the moving image, and the image processing engine 120 sequentially generates image data of each frame of the moving image. According to the digital camera 100 of the present embodiment, the controller 135 as the moving image generator 136 generates a moving image file by performing encoding or the like for sequentially associating the float audio data A10 obtained as described above with the image of each frame. The generated moving image file is recorded in the memory card 142 from the card slot 140, for example.

According to the above operation, for example, when the user performs moving image shooting, the digital camera 100 can perform float recording, and recording accidents such as sound cracking or insufficient sound volume during moving image shooting can be easily avoided. In addition, the user can save the complicated work of adjusting the recording level setting, which is performed in the conventional digital camera when shooting the moving image, and can easily obtain the sound collection result with high accuracy with concentrating on the composition of the moving image shooting, for example. In the digital camera 100 of the present embodiment, the signal processor 190 and the float audio calculator 175 may be examples of the audio processor.

According to the digital camera 100 of the present embodiment, the user can obtain the audio data of the float recording in the moving image file obtained as a result of the moving image shooting of the digital camera 100, for example. For example, compared to a case where an additional device for executing the float recording is separately prepared, it is possible to save the user the trouble of editing such as replacing the audio data of the sound collection result of the separate device with the audio data of the moving image file after the shooting, resulting in facilitating the user to use the float recording.

According to the processing of the combining unit 176 described above, the influence of signal distortion in the H-level audio data A30 is easily avoided by using the L-level audio data A20 for the threshold determination. For example, as shown in FIGS. 6E and 6F, adopting the L-level audio data A30 in a range of a large volume, in which signal distortion may occur in the H-level audio data A20, can suppress the influence of signal distortion in the float audio data A10. Further, as shown in FIGS. 6D and 6F, adopting the H-level audio signal A20 as the sound collection result except for the range of the large sound volume can improve the signal to noise ratio easily.

The combining unit 176 may perform various arithmetic processing for combining the H-level audio data A20 and the L-level audio data A30, and may provide hysteresis to the threshold determination as described above, for example. When the switching between the H-level audio data A20 and the L-level audio data A30 by the threshold determination occurs frequently, the audio data may be temporarily fixed to the L-level audio data A30, for example. By such arithmetic processing, the sense of incongruity in the auditory sense can be reduced in the float audio data A10.

In the present embodiment, the combining unit 176 may perform arithmetic processing such as floating-point arithmetic of combining the H-level audio data A20 and the L-level audio data A30 at a predetermined combination ratio, instead of the arithmetic processing of combining the audio data A20 and A30 withe switching therebetween. The digital camera 100 of the present embodiment can obtain the float audio data A10 also by such arithmetic processing.

### 2-3. Automatic analysis process

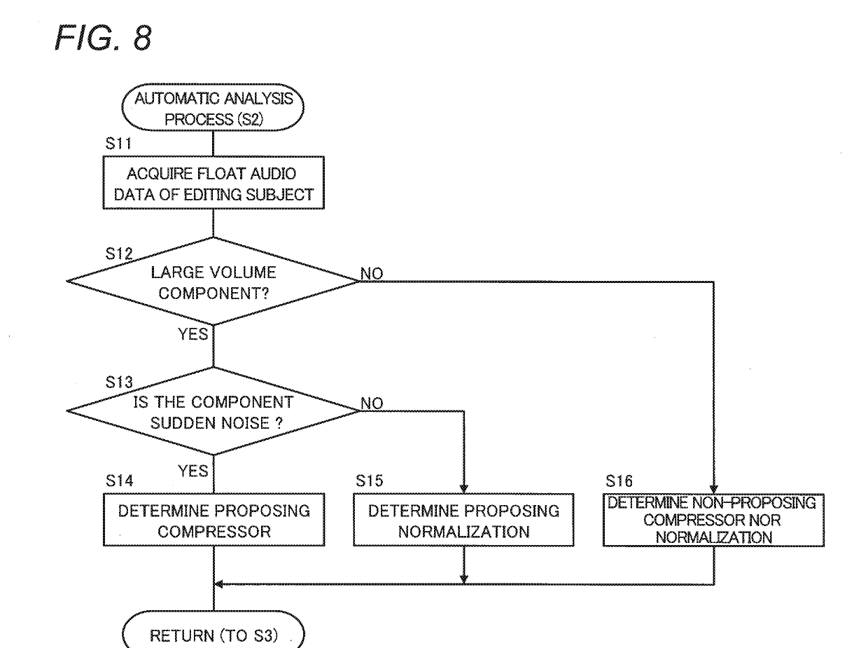

Details of the automatic analysis process in step S2 of FIG. 3 will be described with reference to FIGS. 8 to 10C.

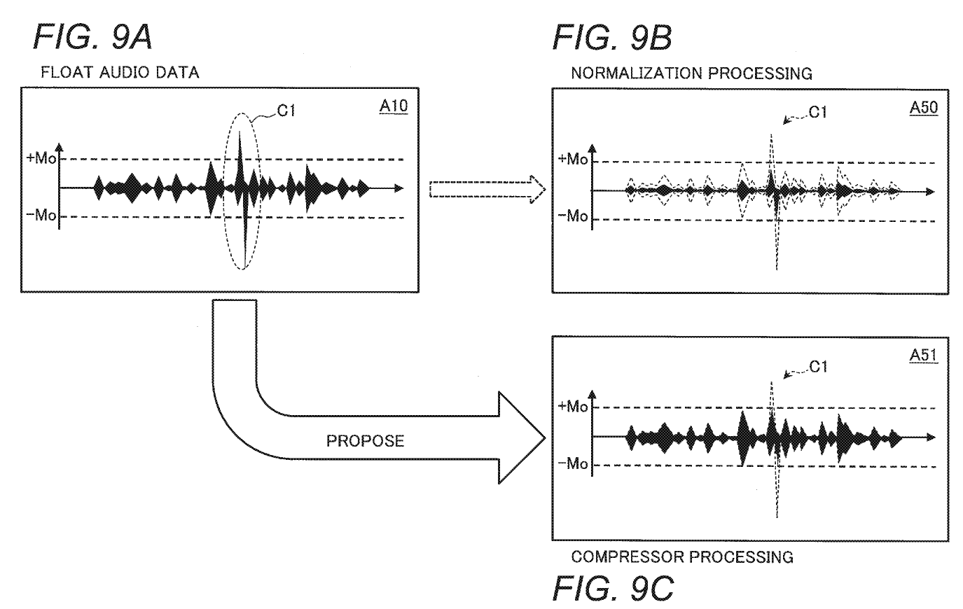

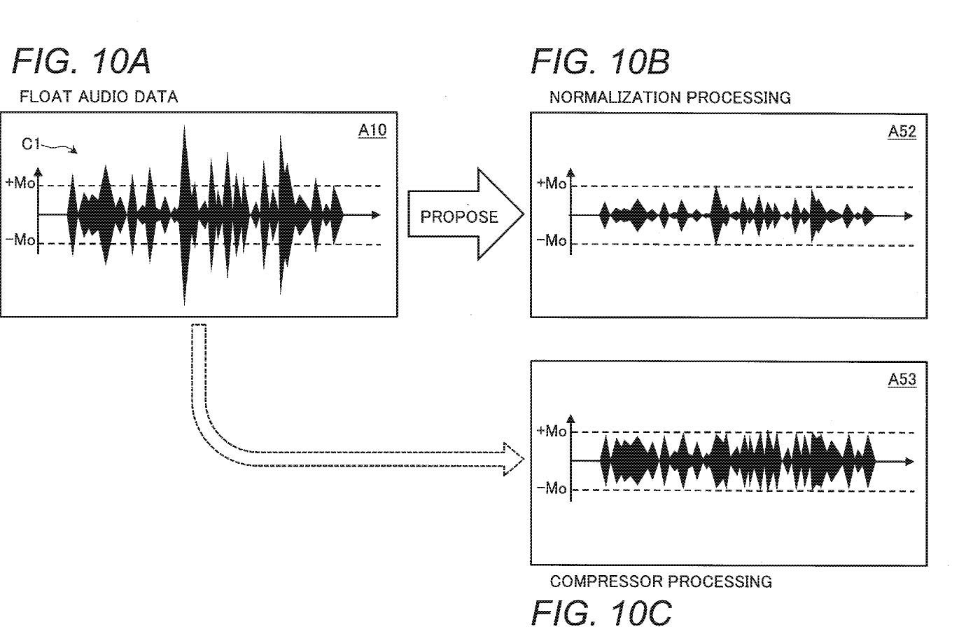

FIG. 8 is a flowchart illustrating an example of automatic analysis process (S2) in the digital camera 100. FIGS. 9A to 9C are diagrams for describing an operation example of proposing compressor processing in the digital camera 100. FIGS. 10A to 10C are diagrams for describing an operation example of proposing the normalization processing in the digital camera 100.

An operation example will be described below as analyzing the feature of the audio in order to propose the compressor processing or the normalization processing as the editing method of the float audio data to the user in the digital camera 100 of the present embodiment. The normalization processing is an example of dynamics control for matching the maximum volume in the float audio data with the maximum value Mo in the linear format with maintaining linearity, for example.

In the flow of FIG. 8, first, the controller 135 acquires the float audio data A10 in the moving image file shot in step S1 of FIG. 3 as an editing subject, for example (S11). In step S11, the controller 135 reads the float audio file A10 of the editing subject from the moving image file stored in the memory card 142 via the card slot 140.

FIG. 9A shows an example of the float audio data A10 as the editing subject. The float audio data A10 of this example illustrates a case where a large volume component C1 due to unexpected sudden noise is recorded in a float recording on the moving image shooting of a scene in which music is played, for example. Examples of the sudden noise include a siren of an ambulance and various traffic noises that are unintentionally included in the performance of the road live show. For such case with the noise included at a large volume, audio editing of dynamics control for suppressing the large volume component C1 can be useful.

Therefore, the controller 135 detects whether or not the large volume component C1 exceeding the volume threshold is present in the float audio data A10 of the editing subject, using the volume threshold such as the maximum value Mo of the linear format (S12). For example, in the example of FIG. 9A, the controller proceeds to YES in step S12 due to the large volume component C1 in the float audio data A10.

For example, the detection in step S12 is performed by sequentially comparing, with the volume threshold, the magnitude of the acoustic pressure (i.e., the volume) at each time in the audio waveform of the float audio data A10. By using the maximum value Mo of the linear format as the volume threshold, it is possible to easily perform the dynamics control of the large volume component C1 that do not fall within the recording range Ro of the linear format when editing the float audio data A10 into the linear audio data.

When the controller 135 detects that the large volume component A10 are present in the float audio data C1 of the editing subject (YES in S12), the controller 135 determines whether or not the large volume component C1 is sudden noise or the like by analyzing the characteristics of the sound with respect to the float audio data A10, for example (S13).

For example, the sound feature analysis of the step S13 is performed using a sound identification model that is a trained model constructed in advance by machine-learning so as to identify whether or not the sound is noise. Such machine learning is performed by supervised learning using, as supervised data, a data set of audio data in which various sudden sounds that are noisy are classified with sudden sounds that are not noisy, for example. For example, the noise classification includes traffic noise, plosives, falling noises, and gusts. The non-noise classification may include musical instrument sounds or singing sounds in musical expressions, relatively loud human voices, animal sounds, and the like. The classification of whether or not the noise is present can be appropriately selected according to the application, for example.

For example, in step S13, the controller 135 inputs the audio data corresponding to the part of the large volume component C1 in the float audio data A10 into the sound identification model described above, and causes the sound identification model to output an identification result of whether or not the part is noise. In this way, in the example of FIG. 9A, the controller 135 can detect the large volume component C1 due to the sudden noise (YES in S13).

When the controller 135 determines that the large volume component C1 in the float audio data A10 is noise (YES in S13), the controller 135 determines the compressor processing as the proposed editing method (S14). The process of step S14 will be described with reference to FIGS. 9B and 9C.

FIG. 9B illustrates linear audio data A50 obtained when the normalization processing is performed on the float audio data A10 of FIG. 9A. If the normalization processing is performed on the float audio data A10 including the noise of the large volume component C1 as illustrated in FIG. 9A, the sound other than the large volume component C1 becomes small as a whole as illustrated in FIG. 9B. Therefore, the sound qualities of the performance sounds and the like, which can be recorded with high accuracy even in the presence of noise in the float audio data A10, would be reduced in the linear audio data A50 of the editing result.

Therefore, the digital camera 100 of the present embodiment proposes compressor processing for the float audio data A10 as shown in FIG. 9A (S14). FIG. 9C illustrates an example of linear audio data A51 obtained by performing compressor processing on the float audio data A10 in FIG. 9A in the digital camera 100 according to the present embodiment.

According to the compressor processing by the digital camera 100 of the present embodiment, the large volume component C1 can be selectively compressed as shown in FIG. 9C with respect to the float audio data A10 as shown in FIG. 9A. Thus, in the linear audio data A51 as the editing result, the audio qualities of other performance sounds and the like can be maintained with suppressing the large volume component C1 of the noise, and the user can easily feel the high accuracy of the float recording.

On the other hand, when the controller 135 determines that the large volume component C1 in the float audio data A10 is not noise (NO in S13), the controller 135 determines the proposed editing method to be the normalization processing (S15). The processing of the step S14 will be described with reference to FIGS. 10A to 10C.

FIG. 10A illustrates float audio data A10 of a different shooting result from that of FIG. 9A. FIG. 10B illustrates linear audio data A52 obtained by performing the normalization processing on the float audio data A10 of FIG. 10A in the digital camera 100 of the present embodiment. FIG. 10C illustrates linear audio data A53 obtained when the compressor processing is performed on the float audio data A10 of FIG. 10A.

The float audio data A10 in the example of FIG. 10A illustrates a case where a part of the performance sound is large in volume in the float recording on the moving image shooting of a scene in which music is played, for example. For example, it is presumed that a specific musical instrument sound such as a cymbal or a drum during playing becomes the large volume component C1. In the present embodiment, the controller 135 can detect that the large volume component C1 is not noise by analyzing the sound characteristics of the step S13, for example (NO in S13).

If the compressor processing is performed on the float audio data A10 as shown in FIG. 10A, the difference in intensity between the instrument sound of the large volume component C1 and the other performance sounds is suppressed as shown in FIG. 10C, resulting in the loss of the intonation of the entire performance.

Therefore, the digital camera 100 of the present embodiment proposes normalization processing for the float audio data A10 as shown in FIG. 10A (S15). According to the normalization processing at this time, as shown in FIG. 10B, the linear audio data A53 as the editing result of the float audio data A10 (FIG. 10A) can be obtained with the change in the strength of the entire audio being maintained. In this way, the user can easily feel the high sound quality of the float recording.

When the controller 135 detects that the large volume component C1 is not present in the float audio data A10 of the editing subject (NO in S12), the controller 135 determines that a proposal not to perform the dynamics control, i.e., neither the compressor processing nor the normalization processing is to be made, for example (S16). In this case, the controller 135 may perform a process of converting the float format into the linear format without particularly performing the dynamics control, and may determine such a process as the proposed content in step S16.

After determining any of steps S14 to S16, the controller 135 ends the automatic analysis process (S2) illustrated in FIG. 8 and proceeds to step S3 in FIG. 3.

According to the automatic analysis process (S2) described above, the digital camera 100 of the present embodiment can analyze the feature of the sound included in the float audio data A10 recorded on the moving image shooting (S12 to S13), and can specify an editing method suitable for the feature of the audio (S14 to S16).

The input of the sound identification model in the sound analysis of the step S13 is not limited to the audio data of the part of the large volume component C1, and may be a part or all of the float audio data A10. The sound identification model may be constructed to identify whether the recorded scene is noisy based on the recorded sound other than the large volume component C1 in the audio data.

The process of step S16 is not limited to the above, and for example, an editing method proposed by the compressor processing may be determined. The compressor processing proposed in step S16 may use dynamics control data having a different curve shape than the dynamics control data D1 in the case of step S14.

According to the compressor processing described above, it is possible to easily perform editing in which a sense of unity is given to a sound of a relatively large volume less than the large volume component C1, for example. In the digital camera 100 of the present embodiment, the dynamics control data D1 (FIG. 5) of the compressor processing may be set in advance to a standard curve shape such that high-quality audio can be obtained in both cases of the step S14 and the S16, for example.

Alternatively, the proposed content of the step S16 is not particularly limited to the compressor processing, and may be normalization processing, or another dynamics control may be proposed as the editing method.

### 2-4. Float Audio Editing Process

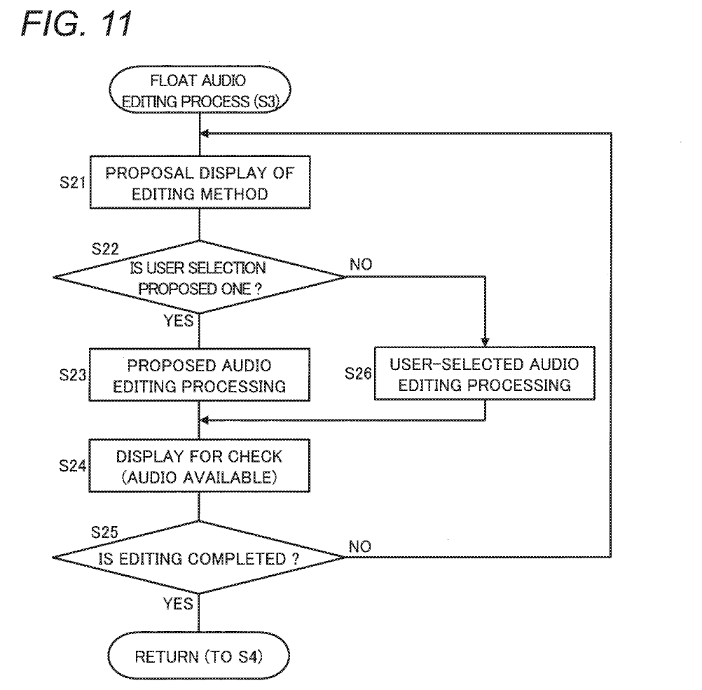

Details of the float audio editing process in step S3 of FIG. 3 will be described with reference to FIGS. 11 to 14. FIG. 11 is a flowchart illustrating float audio editing process (S3) in the digital camera 100 according to the present embodiment.

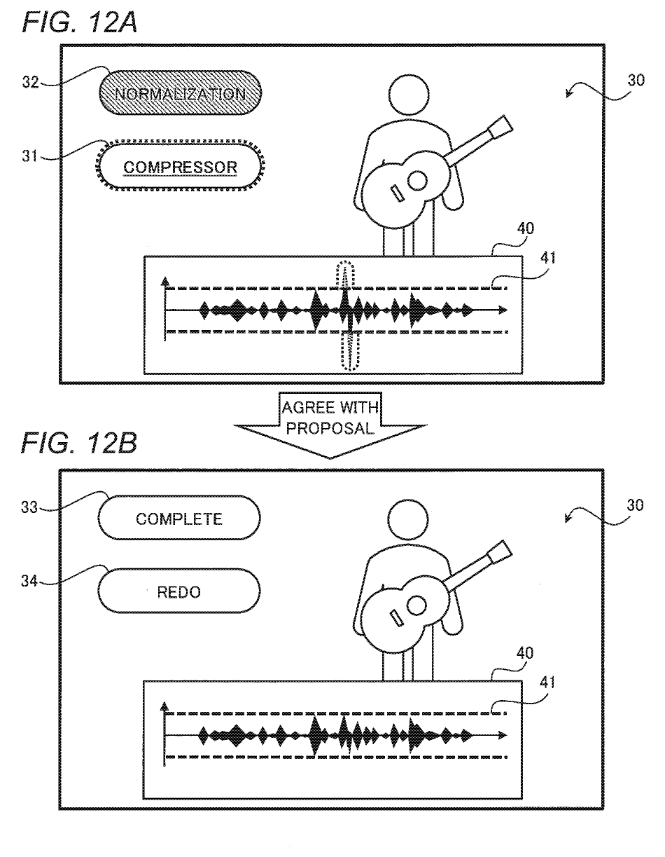

First, based on the result of the automatic analysis process (S2) on the float audio data A10 of the editing subject, the controller 135 performs notification for proposing an editing method for the float audio data A10 to the user on the display monitor 130, for example (S21). A display example in the step S21 is illustrated in FIG. 12A.

FIG. 12A illustrates a display example of a float audio editing screen in the digital camera 100. For example, the proposal screen illustrated in FIG. 12A includes an audio waveform monitor 40, a compressor processing button 31, and a normalization processing button 32, together with the reproduced image 30. The reproduced image 30 in turn displays frame images of a moving image file corresponding to the float audio data A10 of the editing subject, for example.

The audio waveform monitor 40 visualizes the waveform of the audio indicated by the float audio data A10 and the analysis result (S2) of the audio along the time base in the moving image file, for example. In the example of FIG. 12A, the audio waveform monitor 40 highlights a portion exceeding the threshold line 41 in the audio waveform of the float audio data A10. The threshold line 41 indicates a volume threshold corresponding to the maximum value Mo in a linear format, for example.

FIG. 12A illustrates a display example of a case (S14) where the compressor processing is proposed by the automatic analysis process (S2) for the float audio data A10 in the example of FIG. 9. In this case, for example, the controller 135 highlights the compressor processing button 31 on the display monitor 130 so as to indicate that the editing method is a proposed editing method, and meanwhile, grays out the normalization processing button 32 so as to indicate that the content is not a proposed content (S21). Each of the processing buttons 31,32 inputs a user operation for instructing audio processing (i.e., audio editing processing) of the corresponding editing method, for example.

For example, with the float audio editing screen as described above being displayed (S21), the controller 135 receives a user operation in the user interface 150 to determine whether or not the editing method selected by the user is the proposed editing method (S22). For example, in the example of FIG. 12A, the determination of the step S22 is "YES" when the compressor processing button 31 of the proposed content is operated, and is "NO" when the normalization processing button 32 of the non-proposed content is operated.

When the controller 135 determines that the user-selected editing method is the proposed editing method (YES in S22), the controller 135 determines the proposed editing method as the editing method to be applied to the float audio data A10 of the editing subject, and executes the audio editing process by the editing method (S23). For example, in the example of FIG. 12A, when the user agrees with the proposal, the controller 135 executes the compressor processing on the float audio data A10 of the editing subject in step S23.

In step S23 for this case, referring to the dynamics control data D1 (FIG. 5) for the compressor processing, the controller 135 calculates, in a linear format, the volume value of the output audio corresponding to the volume value of the input audio at each time indicated by the float audio data A10 of the editing subject, for example. The dynamics control data D1 is stored in advance in the flash memory 145 of the digital camera 100, for example. For example, the controller 135 sequentially performs the above calculation, to generate linear audio data A51 (FIG. 9C) as an editing result by the compressor processing (S23). Such audio editing processing may be performed using the audio processing engine 170.

Next, the controller 135 outputs information for causing the user to check the result of the audio editing process executed in step S23, for example, on the display monitor 130 or the like (S24). A display example of the step S24 is shown in FIG. 12B.

FIG. 12B illustrates a check screen of float audio editing of a result of agreeing to the proposal in the example of FIG. 12A. In step S24, the controller 135 updates the waveform display of the audio waveform monitor 40 from the proposal screen of FIG. 12A to the proposal screen of FIG. 12B according to the waveform of the output sound in the generated linear audio data A51. This allows the user to visually check the audio state edited from the float audio data A10.

In step S24, the controller 135 may reproduce the sound of the generated linear audio data A51 from the speaker 185 in accordance with the user operation in the user interface 150, for example. For example, the controller 135 may perform sound reproduction at a time desired by the user on the time axis of the moving image file in accordance with a touch operation on the audio waveform monitor 40 on the check screen of FIG. 12B. This allows the user to aurally check the sound being edited from the float audio data A10, and to easily obtain a desired sound. At this time, the controller 135 may perform moving image reproduction, or may sequentially update the reproduced image 30 in synchronization with the sound reproduction.

For example, with the check screen (FIG. 12B) of the float audio editing being displayed, the controller 135 receives a user operation on the user interface 150 to determine whether or not to complete the audio editing (S25). For example, the determination of the step S25 is performed in accordance with the user operation of the completion button 33 and the redo button 34 displayed on the check screen of FIG. 12B.

For example, the user can check the voice being edited on the check screen (FIG. 12B) of the float audio editing, and can operate the redo button 34 in the case that the user wants to redo the audio editing such as changing the editing method. In this case, the controller 135 proceeds to NO in step S25, and executes the processing of step S21 and subsequent steps again, for example.

For example, in the float audio editing screen (FIG. 12A), the user can disagree with the editing method proposed in step S21, and can select a different editing method (NO in S22). For example, when the normalization processing button 32 is operated in the example of FIG. 12A, the controller 135 determines that the user-selected editing method is not the proposed editing method (NO in S22). Then, the controller 135 executes the user-selected normalization processing (S26), and proceeds to step S24.

On the other hand, the user can operate the completion button 33 when a desired editing result is obtained by outputting the information of the step S24. In this case, the controller 135 determines to complete the audio editing (YES in S25), ends the float audio editing process (S3) shown in FIG. 11, and proceeds to step S4 in FIG. 3. In this way, the linear audio data A51 as the editing result of the float audio data A10 is stored (S4), and output to the memory card 142, for example.

According to the above processing, the digital camera 100 of the present embodiment can propose to the user a dynamics control editing method suitable for the float audio data A10 of the editing subject (S21), and edit the float audio data A10 with an operation simple for the user (S22 to S23).

In the above description, the operation example of proposing the compressor processing for the float audio data A10 in the example of FIG. 9 has been described, but the present embodiment is not limited thereto. For example, when the float audio data A10 in the example of FIG. 10 is the editing subject, the controller 135 performs a notification display for proposing the normalization processing instead of the compressor processing in step S21.

In the above case, when the user agrees with the proposal (YES in S22), the controller 135 executes the normalization processing in step S23 to generate the linear audio data A52 (see FIG. 10B). For example, the normalization processing in the digital camera of the present embodiment is performed by an operation of shifting the volume as a whole so as to maintain linearity from the maximum volume to the minimum volume, with the maximum volume in the float audio data A10 as a predetermined value such as the maximum value Mo in the linear format.

In the above description, an example has been described where the display mode of each processing button 31,32 is changed as the notification display of the proposal content, but the present embodiment is not limited thereto. For example, in step S21, the controller 135 may display a message indicating the proposed content on the display monitor 130 (e.g., "Propose performing compressor processing") additionally or alternatively to the change in the display mode of each processing button 31, 32. The notification of the proposal content is not limited to the display on the display monitor 130, and the message may be output as a voice from the speaker 185, for example.

The digital camera 100 according to the present embodiment may receive various editing operations by the user without being limited to the above-described example. For example, the controller 135 may receive a user operation for adjusting the threshold line 41 on the audio waveform monitor 40 (S22), and may perform audio editing processing in which the dynamics control is adjusted according to such an operation (S26). For example, when the user operates the compressor processing button 31 after reducing the threshold line 41, the controller 135 may perform the compressor processing by deforming the curve shape of the dynamics control data D1 corresponding to the threshold line 41.

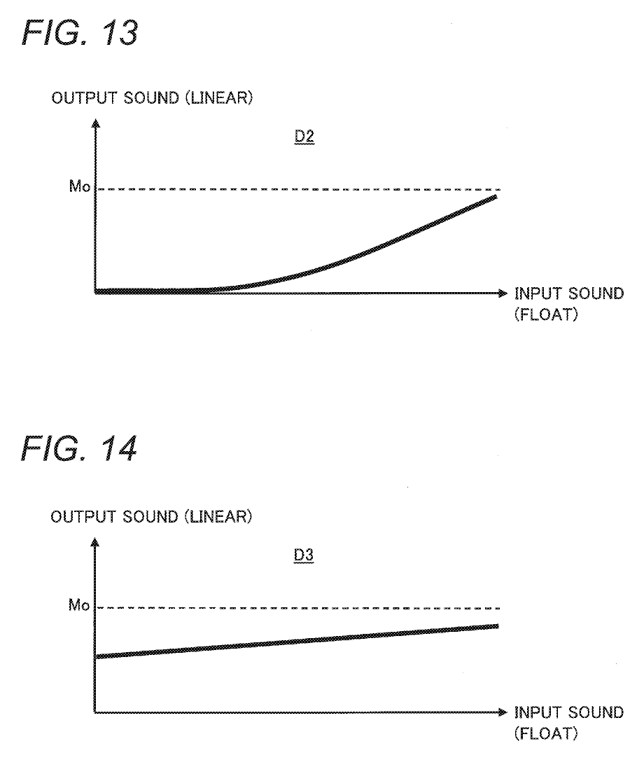

In the digital camera 100 of the present embodiment, the audio editing process of the dynamics control is not limited to the above example, and may be performed by applying various editing methods. Such a modification will be described with reference to FIGS. 13 and 14.

FIG. 13 illustrates the dynamics control data D2 for the expander processing in the digital camera 100 of the present embodiment. For example, the expander processing is a dynamics control editing method for compressing a sound of a relatively small volume as shown in FIG. 13. The expander processing is useful for music applications in which linearity in a large volume region is important, for example.

FIG. 14 illustrates the dynamics control data D3 of the averaging processing in the digital camera 100 of the present embodiment. For example, the averaging processing is an editing method of dynamics control for averagely suppressing a change from a relatively small volume to a large volume as shown in FIG. 14. The averaging processing is useful for an interview application in which importance is attached to uniformization of the volume, for example.

The digital camera 100 according to the present embodiment may perform the dynamics control of the various editing methods as described above on the float audio data A10 in accordance with the selection of the user, for example (S26). As shown in FIGS. 13 and 14, the output sound can be controlled to be equal to or less than the maximum value Mo of the linear format by each of the above-described editing methods, for example.

For example, the controller 135 displays processing buttons corresponding to the respective editing methods on the float audio editing screen (FIG. 12A) in the same manner as the processing buttons 31, 32, to receive a user operation of selecting the respective editing methods on the user interface 150 (S22). The controller 135 can generate linear audio data as an editing result by performing audio editing processing of the corresponding editing method with reference to the dynamics control data D2 and D3 of the selected editing method, as in the above-described compressor processing (S26).

The digital camera 100 according to the present embodiment can also propose a suitable float audio data A10 to the user for the editing method illustrated in FIGS. 13 and 14 (S21). For example, the controller 135 may determine whether the moving image file to be edited includes a specific shooting scene such as an interview or a feature of a sound corresponding thereto in the automatic analysis process (S2), to propose the averaging processing. The automatic analysis process (S2) of such determination is not limited to the feature analysis of the float audio data A10 described above, and may be performed by image analysis in the moving image file.

In the digital camera 100 of the present embodiment, the audio editing process is not limited to the above-described various dynamics controls, and various audio editing processes such as noise removal may be further performed.

### 3. Review

As described above, the digital camera 100, which is an example of an imaging apparatus according to the present embodiment, includes the image sensor 115, which is an example of an image sensor, the audio processing engine 170, which is an example of an audio processor, and the controller 135, which is an example of a controller. The image sensor 115 captures a subject image and generates image data. The audio processing engine 170 collects the input audio during the image capturing by the image sensor 115, and generates the float audio data A10 as an example of the first audio data indicating the input audio in the recording range Rf in the float format as an example of the first dynamic range (S1). The controller 135 edits the float audio data A10 generated by the audio processing engine 170 and outputs linear audio data A51, which is an example of second audio, indicating audio corresponding to input sound in a recording range Ro of a linear format, which is an example of a second dynamic range smaller than the first dynamic range (S3).

According to the digital camera 100 described above, the float audio data A10 of the input sound collected in the relatively wide recording range Rf of the float format is edited to the linear audio data A20 of the narrower recording range Ro, and it can facilitate the user to obtain the editing result of the float recording.

In the digital camera 100 of the present embodiment, the controller 135 edits the float audio data A10 into the linear audio data A51 with reference to the dynamics control data D1, which is an example of the correspondence set between the change in the sound volume in the recording range Rf of the float format and the change in the sound volume in the second dynamic range. Accordingly, the digital camera 100 according to the present embodiment can perform dynamics control on the float audio data A10 to easily obtain a high-quality editing result from the float audio data A10.

In the digital camera 100 of the present embodiment, the controller 135 analyzes the characteristics of the input audio in the float audio data A10, and specifies an editing method suitable for the input audio (S2). Accordingly, the digital camera 100 of the present embodiment can automatically determine an appropriate editing method according to the feature of the audio in the float audio data A10 of the editing subject, and can make it easy for the user to obtain a high-quality editing result. In step S2, the controller 135 may select an editing method suitable for the input sound from among a plurality of editing methods based on at least one of the float audio data A10 and the image data.

In the present embodiment, the digital camera 100 further includes a display monitor 130, which is an example of a notification device that notifies a user of information, and a user interface 150 that inputs a user operation. The controller 135 controls the display monitor 130 to notify the specified editing method (S21), receives a user operation related to the notified editing method in the user interface 150, and determines an editing method to be applied to editing of the float audio file A10 (S22 to S23, S26). Accordingly, the digital camera 100 according to the present embodiment can easily obtain an editing result according to the intention of the user by presenting the automatically specified editing method to the user by notification and editing the float audio file A10 while reflecting the intention of the user with respect to the presented content.

In the digital camera 100 of the present embodiment, the controller 135 determines an editing method to be applied to editing of the float audio data A10 from among compressor processing for editing the float audio data A10 so as to suppress the float audio data A10 as the volume of the input sound increases and editing processing different from the compressor processing such as normalization processing (S22 to S23, S26). This makes it possible to obtain a high-quality editing result in which a large volume is suppressed from the float audio data A10, or to obtain another high-quality editing result by other various editing methods.

In the present embodiment, the digital camera 100 further includes a moving image generator 136 that generates a moving image file by associating the image signal with the float audio data A10 and the linear audio data A51. This enables the digital camera 100 of the present embodiment to make it easier to use the float recording for moving image shooting. For example, the controller 135 may replace the float audio data A10 with the linear audio data A51 in the video file including the float audio data A10, thereby outputting the linear audio data A51.

In the present embodiment, the digital camera 100 further includes the speaker 185, which is an example of an audio output interface that is not capable of reproducing audio based on the float audio data A10 and is capable of reproducing audio based on the linear audio data A51. Accordingly, even in the digital camera 100 that cannot reproduce the float audio data A10, the linear audio data A51 of the editing result can be reproduced, and the user can easily experience the high quality of the audio obtained by the float recording in terms of the auditory sense.

In the digital camera 100 of the present embodiment, the float audio data A10 is configured in a float format having an exponential part 51 and a significand part 52 that define a recording range Rf as a first dynamic range. The linear audio data A51 is in a format different from the float format. The digital camera 100 of the present embodiment can make it easy for the user to obtain the editing result of the float audio data A10 obtained by the float recording.

### Other Embodiments

As described above, the first embodiment has been described as an example of the technique disclosed in the present application. However, the technique in the present disclosure is not limited to this, and is applicable to embodiments in which changes, replacements, additions, omissions, and the like are made as appropriate. In addition, the components described in the above embodiments may be combined to form a new embodiment. Therefore, other embodiments will be exemplified below.

The digital camera 100 that automatically analyzes and proposes an editing method suitable for the float audio data A10 has been described in the first embodiment; however, the digital camera 100 of the present embodiment does not need to make such a proposal. For example, the digital camera 100 according to the present embodiment can execute the audio editing processing by automatically applying the editing method specified by the automatic analysis process (S2) to the float audio data A10. Alternatively, the digital camera 100 according to the present embodiment may determine an editing method to be applied to editing of the float audio data A10 according to a user operation on the user interface 150 without performing the automatic analysis process (S2).

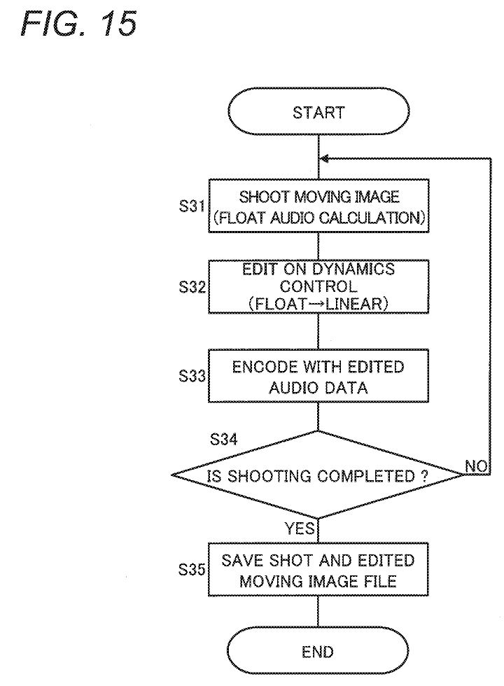

In the above embodiments, an example of the operation of editing the float audio data A10 after the moving image is shot in the digital camera 1 has been described, but the digital camera 1 of the present embodiment may edit the float audio data A10 in real time during the moving image shooting. Such a modification will be described with reference to FIG. 15.

FIG. 15 is a flowchart illustrating an operation of the digital camera 100 according to the modification. In the digital camera 1 of the present embodiment, first, the controller 135 controls each unit of the digital camera 100 so as to execute various operations for each frame in moving image shooting (S31). In step S31, for example, various operations such as image capturing and sound collection before the function of the moving image generator 136 are performed among the same operations as those of the moving image shooting and recording (S1) in the first embodiment.

For example, the audio processing engine 170 according to the present embodiment generates, as a provisional intermediate data, a float audio data A10 for an input sound for frames sequentially captured by the image sensor 115 (S31). In step S31, the signal processor 190 and the float audio calculator 175 operate as in the float recording operation of the first embodiment.

Next, the controller 135 performs the same audio editing process as the various dynamics control in the first embodiment on the float audio data A10 generated as the intermediate audio in the audio processing engine 170, for example, and sequentially generates the edited linear audio data A51 (S32). The process of the step S32 is performed by referring to the dynamics control data D1 set in advance by a user operation of the digital camera 100, for example. The user can set desired dynamics control in the same process as the float audio editing process (FIG. 11) of the first embodiment by performing trial recording before the execution of the process of FIG. 15, for example. Alternatively, the controller 135 may automatically determine the editing method for the float audio data A10.

Next, the controller 135 causes the moving image generator 136 to function in the same manner as in the first embodiment, for example, and performs encoding of a moving image file including the generated linear audio data A51 and the captured image of each frame in association with each other (S33). The controller 135 repeatedly executes the processing of steps S31 to S33 until the completion of the moving image shooting (S34). When the moving image shooting is completed by a user instruction or the like (YES in S34), the controller 135 stores a moving image file of the shooting result in the memory card 142 via the card slot 140, for example (S35). The moving image file encoded at the step S33 may be sequentially recorded before the step S35.

According to the above processing, the digital camera 100 of the present embodiment can perform the same audio editing processing as in the first embodiment (S32) in real-time moving image shooting, and output a moving image with the edited float audio data A10. The digital camera 100 according to the present embodiment may perform live streaming of the moving image shot in real time in this manner. For example, the controller 135 may sequentially transmit the encoded moving image data (S33) including the editing result of the float audio data A10 to the communication network or the external device via the communication module 160.

As described above, in the digital camera 100 of the present embodiment, the controller 135 edits the float audio data A10 to the linear audio data A51 during imaging by the image sensor 115, and causes the moving image generator 136 to generate a moving image file by associating the image A51 with the linear audio (S32 to S33). Accordingly, the digital camera 100 of the present embodiment can output the editing result of the float audio data A10 in the moving image being shot in real time, and can make it easy for the user to use the float recording.

In the above embodiments, the digital camera 100 including the H/L level signal processors 191, 192 as the signal processor 190 for float recording has been described. In the digital camera 100 of the present embodiment, the signal processor 190 does not have to include the H/L level signal processors 191, 192, and may include, for example, a set of an amplifier and an A/D converter, and a control circuit that sequentially controls the gain of the amplifier in accordance with the input sound. By controlling the gain in this manner, sound collection that realizes the dynamic range of the float recording may be performed. In this case, the amplification unit 174 and the combining unit 176 can be omitted in the float audio calculator 175.

In the above embodiments, the digital camera 100 including the signal processor 190 has been described. In the present embodiment, the digital camera 100 does not need to include the signal processor 190, and may receive, from an external sound pickup device, sound picked up for float recording, and generate float audio data A10 in the float audio calculator 175.

In the above embodiments, an example in which the digital camera 100 performs the float recording operation and the audio editing has been described, but the present disclosure is not limited thereto. In the present embodiment, an audio processing device such as various electronic devices other than the imaging apparatus such as the digital camera 100 may perform the float recording operation and the audio editing of the float audio data A10, similarly to the digital camera 100 of the above embodiments. The audio processing device according to the present embodiment may be a sound recorder or a microphone device.

That is, the audio processing device of the present embodiment includes an audio processor that collects an input sound and generates first audio data indicating the input sound in a first dynamic range, and a controller that edits the first audio data generated by the audio processor and outputs second audio data indicating an output sound corresponding to the input sound in a second dynamic range smaller than the first dynamic range. Accordingly, the audio processing device of the present embodiment can make it easier for the user to obtain the editing result of the audio data, similarly to the digital camera 100 of each of the above embodiments. According to the present disclosure, a program for operating a computer that communicates with various electronic devices is provided as such an audio processing device.

In the above embodiments, the audio data in the float format is illustrated as an example of the first audio data. In the present embodiment, the first audio data is not necessarily limited to the float format, and may be various data formats having a first dynamic range capable of securing each resolution between sounds having volumes significantly different from each other than the range of the resolution of the sound, for example.

In the above embodiments, the linear format audio data is illustrated as an example of the second audio data, but the present disclosure is not particularly limited thereto. In the present embodiment, the second audio data may not be in a linear format, and may be in various data formats having a second dynamic range narrower than the first dynamic range. For example, the second audio data may be in a MP3 format, a WMA format, or the like.

In the above embodiments, the memory card 142 is exemplified as a recording medium, and the card slot 140 is exemplified as a recorder of the digital camera 100. In the present embodiment, the recording medium is not limited to a memory card, and may be an external storage device such as an SSD drive. The digital camera 100 according to the present embodiment may upload a moving image file or the like to a cloud server or the like via the communication module 160, for example.

In the above embodiments, the digital camera 100 including the optical system 110 and the driver 112 is illustrated. The imaging apparatus of the present embodiment may not include the optical system 110 and the driver 112, and may be, for example, an interchangeable lens type camera.

In the above embodiments, a digital camera has been described as an example of an imaging apparatus, but the present disclosure is not limited to this. The imaging apparatus of the present disclosure may be an electronic device (e.g., a video camera, a smartphone, a tablet terminal, or the like) having an image shooting function. The audio processing device of the present disclosure may be an electronic device that does not particularly depend on the presence or absence of an image shooting function.

### Exemplary Aspects

Hereinafter, various aspects according to the present disclosure will be exemplified.

A first aspect according to the present disclosure is an imaging apparatus including: an image sensor configured to capture a subject image to generate image data; an audio processor configured to collect an input sound in imaging by the image sensor, to generate first audio data indicating the input sound in a first dynamic range; and a controller configured to edit the first audio data generated by the audio processor to output second audio data indicating output sound corresponding to the input sound in a second dynamic range smaller than the first dynamic range.

According to a second aspect, in the imaging apparatus according to the first aspect, the controller is configured to edit the first audio data into the second audio data, referring to a correspondence set between a change of volume in the first dynamic range and a change of volume in the second dynamic range.

According to a third aspect, in the imaging apparatus according to the first or second aspect, the controller is configured to analyze a feature of the input sound in the first audio data to specify an editing method suitable for the input sound.

In a fourth aspect, the imaging apparatus according to any one of the first to third aspects further includes a notification device configured to notify a user of information; and a user interface configured to input a user operation. The controller is configured to: control the notification device to notify the specified editing method; and receive, via the user interface, the user operation on the notified editing method, to determine the editing method for the first audio data. Alternatively, the imaging apparatus may further include a user interface configured to input a user operation, and the controller may determine the editing method to be applied to the editing of the first audio data according to the user operation in the user interface.

According to a fifth aspect, in the imaging apparatus according to any one of the first to fourth aspects, the controller is configured to determine the editing method for the first audio data from among compressor processing and editing processing different from the compressor processing, the compressor processing editing the first audio data to suppress the first audio data as a volume of the input sound increases.

In a sixth aspect, the imaging apparatus according to any one of the first to fifth aspects further includes a moving image generator configured to generate a moving image file by associating the image data with the first or second audio data.

According to a seventh aspect, in the imaging apparatus according to the sixth aspect, the controller is configured to: edit the first audio data into the second audio data in the imaging by the image sensor; and cause the moving image generator to generate the moving image file by associating the image data with the second audio data.

In an eighth aspect, the imaging apparatus according to any one of the first to seventh aspects further includes an audio output interface that is not capable of reproducing sound based on the first audio data and is capable of reproducing sound based on the second audio data.

According to a ninth aspect, in the imaging apparatus according to any one of the first to eighth aspects, the first audio data is configured in a float format having an exponent part and a significand part that define the first dynamic range, and the second audio data is configured in a data format different from the float format.

A tenth aspect is an audio processing device including an audio processor configured to collect an input sound to generate first audio data indicating the input sound in a first dynamic range; and a controller configured to edit the first audio data generated by the audio processor to output second audio data indicating output sound corresponding to the input sound in a second dynamic range smaller than the first dynamic range.

An eleventh aspect is a non-transitory computer-readable recording medium storing a program or the program for causing a computer to operate as the audio processing device according to the tenth aspect.

As described above, the exemplary embodiments have been described as examples of the technique in the present disclosure. For this purpose, the accompanying drawings and the detailed description are provided.

Therefore, the components described in the accompanying drawings and the detailed description may include not only components essential for solving the problem but also components not essential for solving the problem in order to illustrate the above technique. Therefore, it should not be immediately recognized that the non-essential components are essential because the non-essential components are described in the accompanying drawings and the detailed description.

In addition, since the above-described exemplary embodiments are intended to illustrate the technique in the present disclosure, various changes, substitutions, additions, omissions, and the like can be made within the scope of the claims or the scope of equivalents thereof.

The present disclosure is applicable to an imaging apparatus and an audio processing device that perform a recording operation such as float recording.

1. An imaging apparatus comprising:
an image sensor configured to capture a subject image to generate image data;
an audio processor configured to collect an input sound in imaging by the image sensor, to generate first audio data indicating the input sound in a first dynamic range; and
a controller configured to edit the first audio data generated by the audio processor to output second audio data indicating output sound corresponding to the input sound in a second dynamic range smaller than the first dynamic range.

2. The imaging apparatus according to claim 1,
wherein the controller is configured to edit the first audio data into the second audio data, referring to a correspondence set between a change of volume in the first dynamic range and a change of volume in the second dynamic range.

3. The imaging apparatus according to claim 1,
wherein the controller is configured to analyze a feature of the input sound in the first audio data to specify an editing method suitable for the input sound.

4. The imaging apparatus according to claim 3, further comprising:
a notification device configured to notify a user of information; and
a user interface configured to input a user operation,
wherein the controller is configured to:
control the notification device to notify the specified editing method; and
receive, via the user interface, the user operation on the notified editing method, to determine the editing method for the first audio data.

5. The imaging apparatus according to claim 1,
wherein the controller is configured to determine the editing method for the first audio data from among compressor processing and editing processing different from the compressor processing, the compressor processing editing the first audio data to suppress the first audio data as a volume of the input sound increases.

6. The imaging apparatus according to claim 1,
further comprising a moving image generator configured to generate a moving image file by associating the image data with the first or second audio data.

7. The imaging apparatus according to claim 6,
wherein the controller is configured to:
edit the first audio data into the second audio data in the imaging by the image sensor; and
cause the moving image generator to generate the moving image file by associating the image data with the second audio data.

8. The imaging apparatus according to claim 1,
further comprising an audio output interface that is not capable of reproducing sound based on the first audio data and is capable of reproducing sound based on the second audio data.

9. The imaging apparatus according to claim 1,
wherein the first audio data is configured in a float format having an exponent part and a significand part that define the first dynamic range, and
the second audio data is configured in a data format different from the float format.

10. An audio processing device comprising:
an audio processor configured to collect an input sound to generate first audio data indicating the input sound in a first dynamic range; and
a controller configured to edit the first audio data generated by the audio processor to output second audio data indicating output sound corresponding to the input sound in a second dynamic range smaller than the first dynamic range.

11. A non-transitory computer-readable recording medium storing a program for causing a computer to operate as the audio processing device according to claim 10.
